(19) United States
(12) Patent Application Publication
(10) Pub. No.: US 2005/0052386 A1
(43) Pub. Date: Mar. 10, 2005

(54) Method of processing image signals for improved image quality

(76) Inventors: Su-Hyun Kwon, Suwon-si (KR); Seung-Woo Lee, Seoul (KR)

Correspondence Address: DLA PIPER RUDNICK GRAY CARY USA, LLP, 2000 UNIVERSITY AVENUE, E. PALO ALTO, CA, 94303-2248, US

(21) Appl. No.: 10/928,379

(22) Filed: Aug. 27, 2004

(30) Foreign Application Priority Data
Aug. 28, 2003 (KR) 2003-0060012
Oct. 20, 2003 (KR) 2003-0073148

(51) Int. Cl. G09G 3/36

(52) U.S. Cl. 345/87; 345/204

(57) ABSTRACT

A method and device for improving image quality without the attendant cost-increasing factors such as a high number of frame memories and high power consumption is presented. In one aspect, the invention is a signal processing device for a display unit that includes a signal processor and a frame memory. The signal processor receives image data in a first format and generates a modified image data in a second format that has a different bit number and frequency than the first format. The signal processing device may include a signal processor, a data output unit, and a frame memory (e.g., DDR memory). The signal processor receives image data having a given data rate and divides the image data into two sets of image data. The data output unit receives the sets of image data and generates a recombined image data having a higher data rate.

### RELATED APPLICATIONS

This application claims priority, under 35 U.S.C. §119, from Korean Patent Application No. 10-2003-0060012 filed on Aug. 28, 2003 and Korean Patent Application No. 10-2003-0073148 filed on Oct. 20, 2003, both of which are incorporated by reference herein.

### BACKGROUND OF THE INVENTION

1. Field of the Invention

The present invention relates to signal processing device and method, and a display device including a signal processing device.

2. Description of Related Art

A liquid crystal display (LCD) includes a pair of panels with field generating electrodes and a liquid crystal layer with dielectric anisotropy disposed between the two panels. An electric field is formed in the liquid crystal layer by using the electrodes, and the desired images are generated by adjusting the electric field to control the light transmittance through the liquid crystal layer. The LCD devices include flat panel display (FPD) devices, which frequently come in the form of TFT-LCDs that use thin film transistors (TFTs) for pixel control.

TFT-LCDs, which were used primarily as computer monitors in the past, are becoming utilized more for entertainment display screens such as television screens. As a result, it has become more important for TFT-LCDs to display quality moving images. However, because TFT-LCDs were traditionally not used to display fast moving images, some improvement is needed for the signal control technology in these devices. Currently, the liquid crystal molecules do not respond to the applied electric field fast enough to display clean fast-moving images. It takes a certain length of time for the liquid crystal capacitor to be charged to a target voltage. When the difference between the target voltage and the previous voltage is large, the liquid crystal capacitor may take a longer than desired length of time to reach the target voltage. A “liquid crystal capacitor” refers to the pair of electrodes that generate the electric field and the liquid crystal layer disposed therebetween.

One of the solutions for the problem of long liquid crystal layer charge time is dynamic capacitance compensation (DCC). The DCC method entails applying a modified voltage, which is higher than a target voltage, to the liquid crystal capacitor to take advantage of fact that the response time decreases as the voltage across the liquid crystal capacitor increases.

However, because DCC determines the modified voltage based on a comparison of two or three frames, it requires at least one frame memory to store the image data of a frame. The frame memory requirement is undesirable because it increases the production cost and the area of a control board.

As an alternative, a DDR (double data rate) memory may be used as the frame memory. However, the DDR memory requires high-frequency data processing speed, which is not always available. Thus, a method for determining the modified voltage without the extra cost of the frame memory or limiting conditions like high-frequency processing speed is desirable.

### SUMMARY OF THE INVENTION

The invention includes a method of reducing the required number of frame memories by converting the bit number and frequency of image data.

In one aspect, the invention is a signal processing device for a display unit that includes a signal processor and a frame memory. The signal processor receives current image data in a first format and generates a modified current image data in a second format, the first format having a first bit number and a first frequency and the second format having a second bit number and a second frequency. The frame memory stores the image data in the second format. The invention also includes a display device including the above signal processing device.

In another aspect, the invention is a method of processing data in a display device. The method entails receiving current image data having a first bit number and a first frequency, reformatting the current image data by rearranging the bits to a second bit number, changing the first frequency to a second frequency, and storing the current image data having the second bit number and the second frequency in a frame memory. The modified current image data is generated by using the current image data.

The invention also includes a method of processing data in a display device upon receipt of a current image data D(N), which includes a current first row data D(N)₁, a current second row data D(N)₂, and a current third row data D(N)₃. The method entails storing D(N)₁, into a first line memory of a plurality of line memories in response to receiving D(N)₁, each line memory being capable of storing image data for a pixel row. Then, in response to receiving D(N)₂, the current second row data D(N)₂ is stored into a second line memory of the plurality of line memories, and D(N)₁ and D(N)₂ are written from the first line memory and the second line memory, respectively, into a first frame memory. Also in response to receiving D(N)₂, previous first row data D(N−1)₁ and second row data D(N−1)₂ are read from the second frame memory and stored in third and fourth line memories. The writing of D(N)₁ and D(N)₂ into the first frame memory and the reading of D(N−1)₁ and D(N−1)₂ from the second frame memory occur substantially simultaneously.

The invention is also a method of processing data in a display device having a signal processor with a first memory, a second memory, a third memory, and a fourth memory and a first frame memory and a second frame memory that are separate from the signal processor. The method entails storing a first portion of first image data D(N) into the first memory. The method also entails simultaneously storing a second portion of the first image data D(N) into the second memory, writing the first portion of the first image data D(N) from the first memory to the first frame memory, and reading a first portion of a second image data D(N−1) from the second frame memory into the third memory. Then, the first portion of the second image data D(N−1) is read from the third memory, the first portion of the second image data D(N−1) is read into the first frame memory, a first portion of a third image data D(N−2) is read into the second frame memory, the first portion of the third image data D(N−2) is stored in the fourth memory, and the first, second, and third image data are compared to generate a modified image data.

In yet another aspect, the invention is a signal processing device for a display unit. The device includes a signal processor and a data output unit. The signal processor receives image data having a first data rate and divides the image data into a first subset of image data and a second subset of image data. The data output unit receiving the first subset and the second subset of image data and generating a recombined image data having a second data rate. The recombined image data are stored in a frame memory according to a first clock rate.

In another aspect, the invention is a signal processing device for a display unit, wherein the device includes a double data rate (DDR) memory, a data input unit, and a signal processor. The signal processor receives image data from the DDR memory and generates a first subset of image data and a second subset of image data. The data rate of the first subset and the second subset of image data is half of the data rate of the image data received from the memory. The signal processor receives the first and second subsets of image data.

The invention also includes display devices made with the above-described signal processing devices.

### BRIEF DESCRIPTION OF THE DRAWINGS

FIG. 1 is a block diagram of an LCD according to an embodiment of the present invention;

FIG. 2 is an equivalent circuit diagram of a pixel of an LCD according to an embodiment of the present invention;

FIG. 3 is a block diagram of a signal processing device 40 according to an embodiment of the present invention;

FIG. 4 is an exemplary block diagram of a signal processor of the signal processing device shown in FIG. 3;

FIG. 5 illustrates exemplary waveforms of input signals entering the signal processor shown in FIG. 4;

FIG. 6 illustrates exemplary waveforms of output signals from the data converter;

FIG. 7 illustrates exemplary waveforms of output signals from the internal memory and the data output block;

FIG. 8 is a block diagram of a signal processing device according to another embodiment of the present invention;

FIGS. 9 and 10 illustrate exemplary waveforms of input and output signals of the signal processor shown in FIG. 8, respectively;

FIG. 11 illustrates exemplary waveforms of the image data read from or written into the frame memories;

FIGS. 12 and 13 illustrate an example of the operation of the signal processor shown in FIG. 8 during the input of N-th and (N+1)-th frames, respectively;

FIGS. 14 and 15 illustrate another example of the operation of the signal processor shown in FIG. 8 during the input of N-th and (N+1)-th frames, respectively;

FIG. 16 is a block diagram of a signal processing device including a data output unit according to an embodiment;

FIG. 17 is a timing chart of signals of elements of the signal processing device shown in FIG. 16;

FIG. 18 is a block diagram of a signal processing device including a data input unit according to an embodiment;

FIG. 19 is a timing chart of signals of elements of the signal processing device shown in FIG. 18;

FIG. 20 is a block diagram of a signal processing device including a data output unit according to another embodiment;

FIG. 21 is a timing chart of signals of elements of the signal processing device shown in FIG. 20;

FIG. 22 is a block diagram of a signal processing device including a data input unit according to another embodiment; and

FIG. 23 is a timing chart of signals of elements of the signal processing device shown in FIG. 22.

### DETAILED DESCRIPTION OF PREFERRED EMBODIMENTS

The present invention will now be described in more detail with reference to the accompanying drawings, which show the preferred embodiments of the invention. This invention may, however, be embodied in many different forms and should not be construed as being limited to the embodiments set forth herein.

Now, signal processing devices and methods, and display devices including signal processing devices according to embodiments of the present invention will be described in detail with reference to the accompanying drawings.

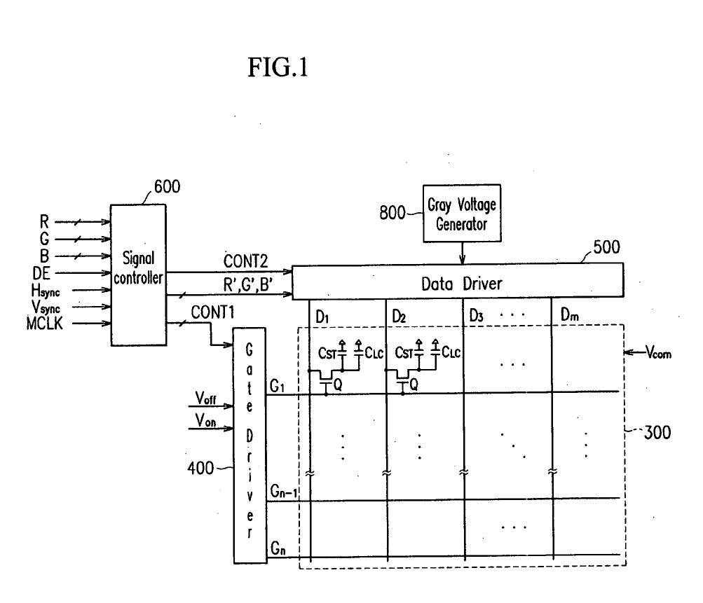

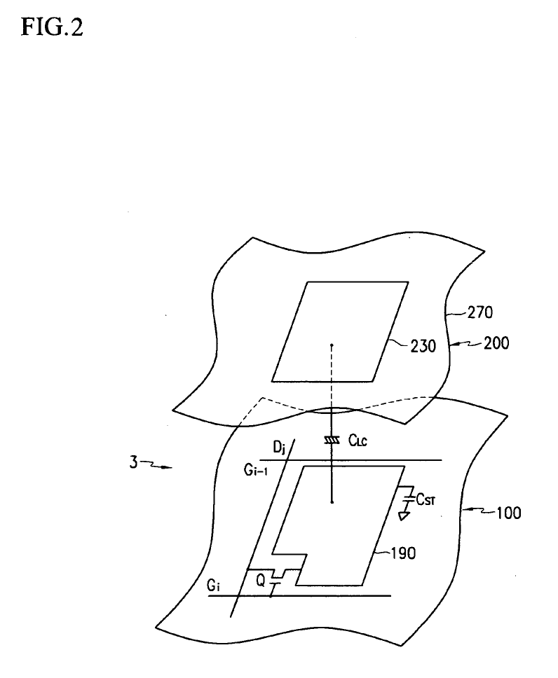

An LCD according to an embodiment of the present invention will be described in detail with reference to FIGS. 1 and 2.

FIG. 1 is a block diagram of an LCD device according to an embodiment of the invention, and FIG. 2 is a diagram of a pixel in the LCD device of FIG. 1.

The LCD device of FIG. 1 includes an LC panel assembly 300 as well as a gate driver 400 and a data driver 500 that are connected to the LC panel assembly 300. A gray voltage generator is connected to the data driver 500. The gate driver 400 and the data driver 500 are controlled by the signal controller 600. The LC panel assembly 300 includes a plurality of display signal lines that define the pixels. The display signal lines includes gate lines G₁-Gn and data lines D₁-Dₘ. The pixels are arranged substantially in a matrix.

The gate lines G₁-Gn transmit gate signals (also referred to as “scanning signals”) and the data lines D₁-Dₘ transmit data signals. The gate lines G₁-Gn extend substantially parallel to one another. The data lines D₁-Dₘ extend substantially parallel to one another and in a direction that is substantially perpendicular to the direction in which the gate lines G₁-Gn extend.

Each pixel includes a switching element Q connected to the signal lines G₁-Gₙ and D₁-Dₘ, an LC capacitor C_{LC}, and a storage capacitor C_{ST}. The LC capacitor C_{LC} and the storage capacitor C_{ST} are connected to the switching element Q. In some embodiments, the storage capacitor C_{ST} may be omitted.

FIG. 2 shows that the switching element Q is provided on a lower panel 100 and has three terminals: a control terminal connected to one of the gate lines G₁-Gₙ, an input terminal connected to one of the data lines D₁-Dₘ, and an output terminal connected to both the LC capacitor C_{LC} and the storage capacitor C_{ST}.

The LC capacitor C_{LC} includes a pixel electrode 190 provided on the lower panel 100 and a common electrode 270 provided on the upper panel 200 as two terminals. The LC layer 3 disposed between the two electrodes 190 and 270 functions as the dielectric material for the LC capacitor C_{LC}. The pixel electrode 190 is connected to the switching element Q, and the common electrode 270 is connected to the common voltage V_{com} and covers the entire surface of the upper panel 200. The common electrode 270 may be provided on the lower panel 100, and both electrodes 190 and 270 may have shapes of bars or stripes.

The storage capacitor C_{ST} is an auxiliary capacitor for the LC capacitor C_{LC}. The storage capacitor C_{ST} includes the pixel electrode 190 and a separate signal line (not shown) that is provided on the lower panel 100. The separate signal line overlies the pixel electrode 190 via an insulator, and is supplied with a predetermined voltage such as the common voltage V_{com}. Alternatively, the storage capacitor C_{ST} includes the pixel electrode 190 and an adjacent gate line (e.g., a previous gate line) that overlies the pixel electrode 190 and sandwiches an insulating layer therebetween.

For a color display device; each pixel can represent a color by including one of red, green, and blue color filters 230. The color filter 230 is positioned over the pixel electrode 190. The color filter 230 shown in FIG. 2 is provided in an area of the upper panel 200. In alternative embodiments, the color filters 230 are positioned on or under the pixel electrode 190 and are part of the lower panel 100.

Although not shown, one or more polarizers are attached to at least one of the panels 100, 200.

Referring back to FIG. 1, the gray voltage generator 800 generates two sets of a plurality of gray voltages related to the transmittance of the pixels. The gray voltages in one set have a positive polarity with respect to the common voltage V_{com}, while the gray voltages in the other set have a negative polarity with respect to V_{com}.

The gate driver 400 is connected to the gate lines G₁-Gₙ of the panel assembly 300 and synthesizes the gate-on voltage Vₒₙ and the gate-off voltage V_{off} from an external device to generate the gate signals for application to the gate lines G₁-Gₙ. The data driver 500 is connected to the data lines D₁-Dₘ of the panel assembly 300 and applies data voltages, selected from the gray voltages supplied from the gray voltage generator 800, to the data lines D₁-Dₘ.

The signal controller 600 controls the gate driver 400 and the data driver 500. The signal controller 600 receives input image signals R, G, and B and input control signals controlling the display thereof such as a vertical synchronization signal Vsync, a horizontal synchronization signal Hsync, a main clock MCLK, and a data enable signal DE, from a graphics controller (not shown). After generating gate control signals CONT1 and data control signals CONT2 and processing the image signals R, G, and B suitable for the operation of the panel assembly 300 on the basis of the input control signals and the input image signals R, G, and B, the signal controller 600 provides the gate control signals CONT1 to the gate driver 400, and transmits the processed image signals R′, G′, and B′ as well as the data control signals CONT2 to the data driver 500. At this time, the image type detector 620 of the signal controller 600 determines the type of the image, for example whether it is a still image or motion image, based on the difference in grays of the image data R, G, and B between a previous frame and the present frame. Thereafter, the signal controller 600 modifies the image data in accordance with the image type.

The gate control signals CONT1 include a vertical synchronization start signal STV for informing the start of a frame, a gate clock signal CPV for controlling the ouptut time of the gate-on voltage Von, and an output enable signal OE for defining the duration of the gate-on voltage Von.

The data control signals CONT2 include a horizontal synchronization start signal STH for informing the start of a horizontal period, a load signal LOAD for instructing to apply the data voltages to the data lines D₁-Dₘ, an inversion control signal RVS for reversing the polarity of the data voltages (with respect to the common voltage V_{com}), and a data clock signal HCLK.

The data driver 500 receives a packet of the image data R′, G′, and B′ for a pixel row from the signal controller 600 and converts the image data R′, G′, and B′ into analog data voltages selected from the gray voltages supplied from the gray voltage generator 800 in response to the data control signals CONT2 from the signal controller 600. Thereafter, the data driver 500 applies the data voltages to the data lines D₁-Dₘ.

In response to the gate control signals CONT1 from the signal controller 600, the gate driver 400 applies the gate-on voltage Vₒₙ to the gate line G₁-Gₙ, thereby turning on the switching elements Q connected thereto. The data voltages applied to the data lines D₁-Dₘ are supplied to the pixels through the activated switching elements Q.

The difference between the data voltage and the common voltage V_{com} is represented as a voltage across the LC capacitor C_{LC}, which is sometimes referred to as the “pixel voltage.” The LC molecules in the LC capacitor C_{LC} have orientations depending on the magnitude of the pixel voltage, and the molecular orientations determine the polarization of light passing through the LC layer 3 (see FIG. 2). The polarizer(s) converts light polarization into a certain level of light transmittance.

During a frame, all gate lines G₁-Gₙ are sequentially supplied with the gate-on voltage Vₒₙ by repeating the above procedure by a unit of the horizontal period (which is indicated by 1H and equal to one period of the horizontal synchronization signal Hsync, the data enable signal DE, and a gate clock signal). Thus, thereby data voltages are applied to all pixels during a frame. Between frames, the inversion control signal RVS applied to the data driver 500 is controlled such that the polarity of the data voltages is reversed (which is called “frame inversion”). The inversion control signal RVS may be also controlled such that the polarity of the data voltages flowing in a data line in one frame are reversed (which is called “line inversion”), or the polarity of the data voltages in one packet are reversed (called “dot inversion”).

Now, a signal processing device that can be used with the above-described LCD will be described in detail.

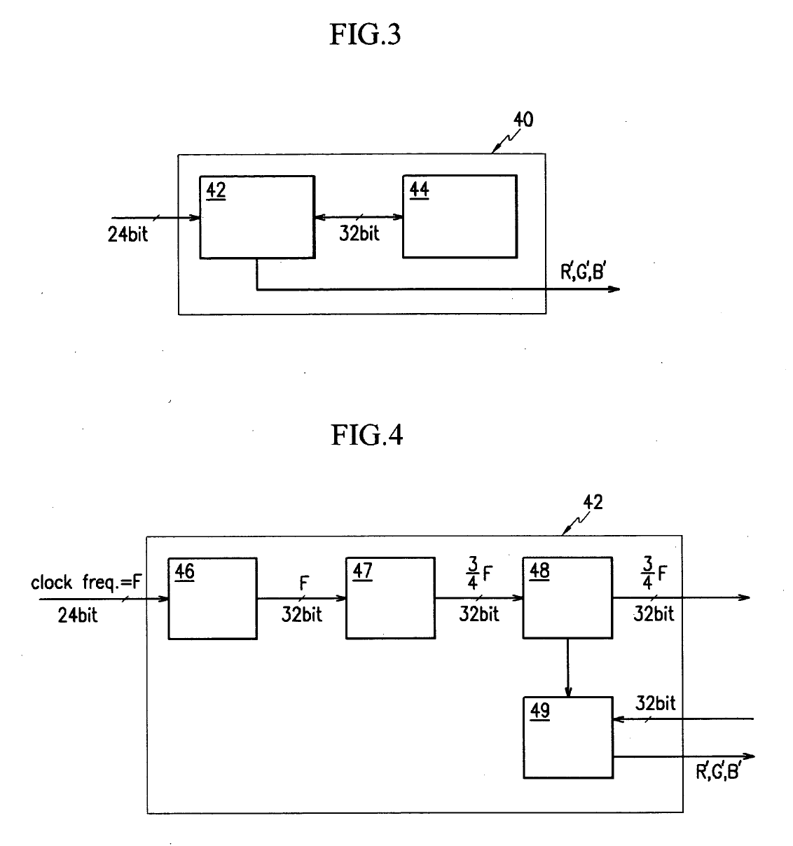

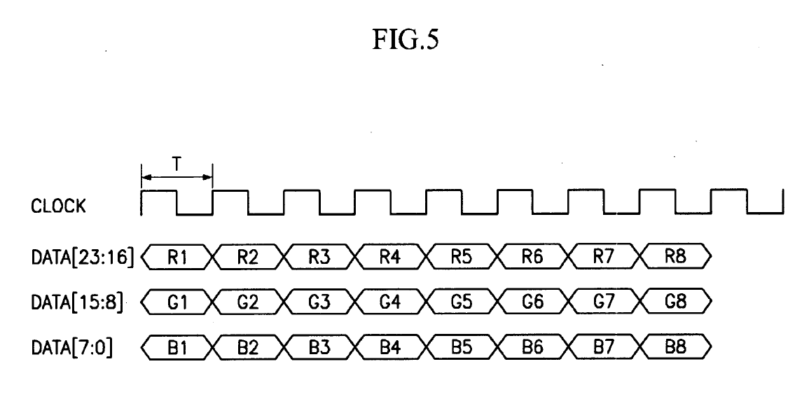

FIG. 3 is a block diagram of a signal processing device 40 according to an embodiment of the present invention and FIG. 4 is an exemplary block diagram of a signal processor of the signal processing device shown in FIG. 3.

As shown in FIG. 3, a signal processing device 40 according to an embodiment of the present invention includes a signal processor 42 and a frame memory 44 connected thereto. An input and an output of the signal processor 42 serve as an input and an output of the signal processing device 40.

The signal processor 42 includes a data converter 46, an internal memory 47 connected to the data converter 46, a data output block 48 connected to the internal memory 47, and a data modifier 49 connected to and having an output that serves as the output of the signal processing device 40.

The data converter 46 receives 24-bit image data R, G and B from an external device and converts the 24-bit image data (R, G and B) into 32-bit data suitable for the frame memory 44. The 24-bit input image data include 8-bit red sub-data R, 8-bit green sub-data G, and 8-bit blue sub-data B and are transmitted at a first predetermined clock frequency, for example, 108 MHz, and the converted 32-bit data are also transmitted at the first predetermined clock frequency.

The 32-bit data from the data converter 46 are stored in a temporary storage, such as the internal memory 47. The internal memory 47 has an input terminal and an output terminal separated from each other such that an output frequency is different from an input frequency. For example, the input terminal of the internal memory 47 is supplied with a clock signal having the first predetermined frequency (e.g., 108 MHz), while the output terminal of the internal memory 47 is supplied with a clock signal having a second predetermined frequency, for example, 81 MHz that is three fourths of the first predetermined frequency. The internal memory 47 may include FIFO (First-In-First-Out) memory or Dual-Port RAM.

The data output block 48 reads out the 32-bit data from the internal memory 47 and writes the data into the frame memory 44 at the second predetermined frequency.

Now, the conversion of the frequency and the bit number of the image data in the signal processor 42 is described in detail.

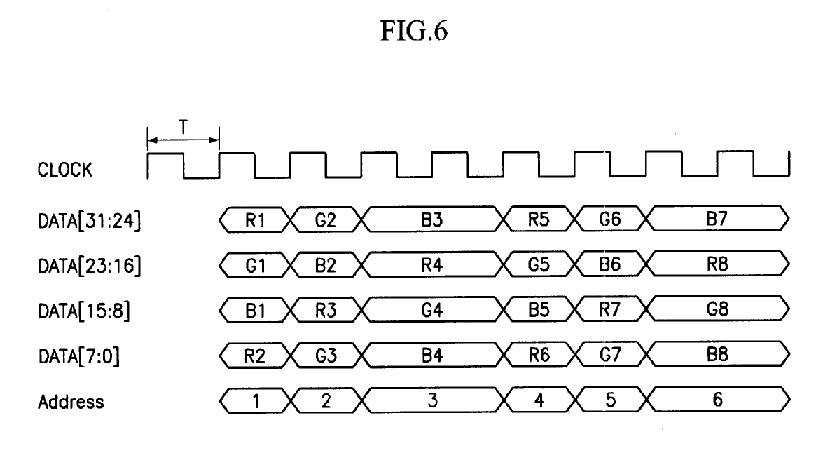

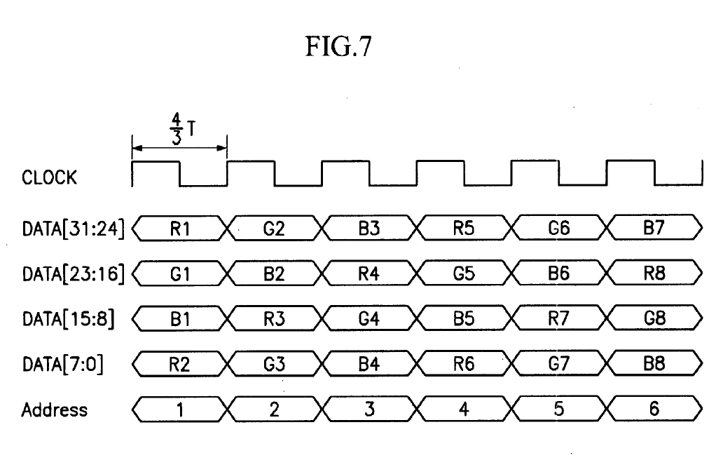

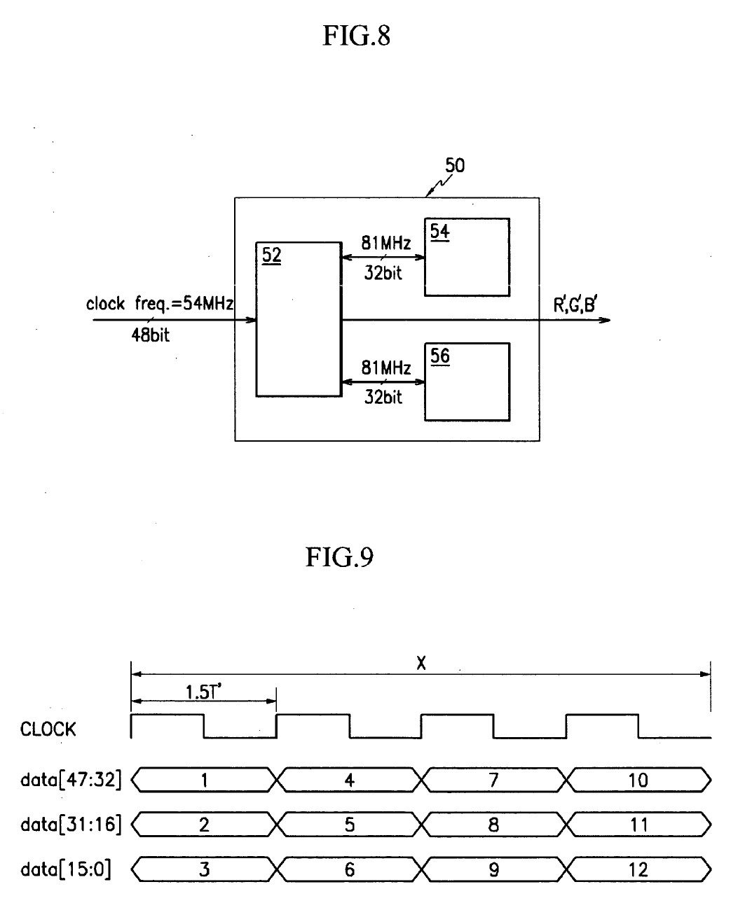

FIG. 5 illustrates exemplary waveforms of input signals entering the signal processor shown in FIG. 4, FIG. 6 illustrates exemplary waveforms of output signals from the data converter, and FIG. 7 illustrates exemplary waveforms of output signals from the internal memory and the data output block.

FIG. 5 shows that each of the 24-bit input image data R, G and B entering the signal processor 42 includes three 8-bit sub-data (data[23: 16], data[15:8], and data[7:0]). Reference character “T” shown in FIG. 5 indicates a period corresponding to the first predetermined frequency.

FIG. 6 shows the 32-bit data (data[31:24], data[23:16], data[15:8], and data[7:0]) converted by the data converter 46. In detail, the data converter 46 synchronizes three input sub-data R1, G1, and B1 input at a first input clock and an input sub-data R2 input at a second input clock to generate a first 32-bit image data including four sub-data R1, G1, B1, and R2, and the data converter 46 outputs the first 32-bit image data at a first output clock. Similarly, the data converter 46 synchronizes two input sub-data G2 and B2 input at the second input clock and two sub-data R3 and G3 input at a third input clock to generate a second 32-bit image data including four sub-data G2, B2, R3, and G3, and the data converter 46 outputs the second 32-bit image data at a second output clock. Likewise, an input sub-data B3 input at the third input clock and three sub-data R4, G4, and B4 input at a fourth input clock are synchronized to form a third 32-bit image data including four sub-data B3, R4, G4, and B4 that is outputted at a third output clock. At a fourth output clock, the data converter 46 outputs the third 32-bit image data B3, R4, G4, and B4 again. During four clocks (or 4T), the number of the 32-bit output image data R1-B4 outputted from the data converter 46 is then equal to that of the 24-bit input image data R1-B4 input into the data converter 46.

As described above, the output clock frequency of the internal memory 47, i.e., the second predetermined clock frequency is equal to three fourths of the input clock frequency of the internal memory 47, i.e., the first predetermined clock frequency. In other words, the output clock period (4T/3) of the internal memory 47 is equal to four thirds of the input clock period (T) of the internal memory 47. FIG. 7 shows that three 32-bit image data R1-B4 are outputted from the internal memory 47 during three output clock periods (4T). Accordingly, the number of the output data is equal to that of the input data during a given period (4T).

To summarize, the conversion of the 24-bit input image data into the 32-bit output image data along with the conversion of the input clock frequency into the output clock frequency equal to 24/32 times, i.e., ¾ times the input clock frequency equalizes the numbers of the input image data and the output image data for a given period. In other words, the numbers of the input image data and the output image data for a given period are the same when the bit number of the input image data multiplied by the input clock frequency is equal to the bit number of the output image data multiplied by the output clock frequency.

The above-described signal processor 42 converts the 24-bit data into the 32-bit data so that the frame memory 44 capable of storing 32-bit image data may fully use its storage.

For example, an SXGA (super extended graphics array) display device having 1280×1024 pixels requires 1,280×1,024×24=31,457,280 bits of image data for a frame since a pixel requires 24 bits of image data. If 24-bit data are supplied to a frame memory capable of storing 32-bit data, remaining 8-bit data storage are useless and total storage required for storing a frame data of an SXGA display device, which is to be provided by the frame memory, is equal to 1,280×1,024×32=41,943,040 that is larger than the total bits of the data. As a result, a 64 Mbit frame memory can store only one frame data for the SXGA display device. However, the above-described frame memory 44, if it has a 64 Mbit storage capacity, can store two frame data for the SXGA display device.

The frame memory 44 stores 32-bit data for two frames in a way that newly input frame data are stored as a substitute of previously stored one of two frame data stored therein.

The data modifier 49 receives the image data for two frames from the frame memory 44 and modifies the image data. In detail, the data modifier 49 compares the image data between the two frames and processes the image data to generate modified data R′, G′, and B′ based on the comparison. For example, the data modifier 49 compares the image data of a frame (referred to as a “current frame” hereinafter) with the image data of another frame immediately previous to the current frame (referred to as a “previous frame” hereinafter) and modifies the image data of the current frame (referred to as the “current image data” hereinafter). The image data of one of the two frame data, for example, the current image data may be supplied from the data output block 48 instead of the frame memory 44.

The modified image data R′, G′, and B′ are transmitted to the data driver 500 shown in FIG. 1.

The signal processing device 40 may be included into the signal controller 600, and in particular, the signal controller 600 only includes the signal processor 42.

The conversion of the bit number of the image data and the frequency according to this embodiment reduces the required number of frame memories and reduces the clock frequency to decrease electromagnetic interference.

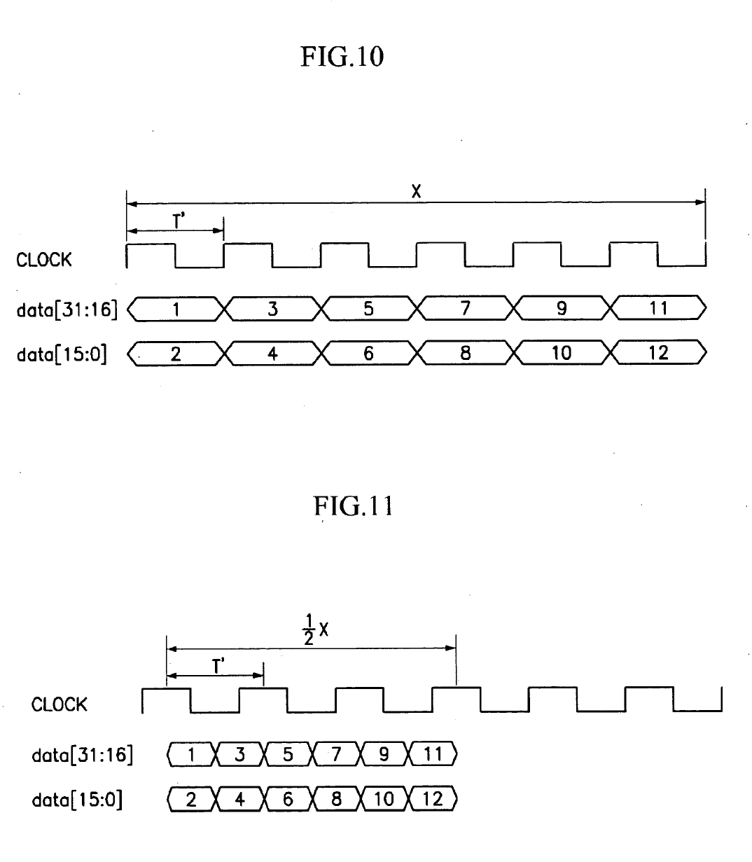

Now, a signal processing device according to another embodiment of the present invention is described in detail with reference to FIG. 8.

FIG. 8 is a block diagram of a signal processing device according to another embodiment of the present invention.

Referring to FIG. 8, a signal processing device 50 according to this embodiment includes a signal processor 52 and first and second frame memories 54 and 56 connected to the signal processor 52.

The first and the second frame memories 54 and 56 may include DDR RAM (double-data-rate random access memory). The DDR RAM, which is also referred to as DDR SDRAM (synchronous dynamic RAM), reads and writes at both rising and falling edges of a clock applied thereto. On the contrary, SDR SDRAM (single data rate SDRAM) or SDRAM reads or writes at either a rising edge or a falling edge of a clock. Accordingly, the DDR RAM has a speed twice that of the SDRAM. In other words, the time required for storing a given amount of data by the DDR RAM is half of that by the SDRAM.

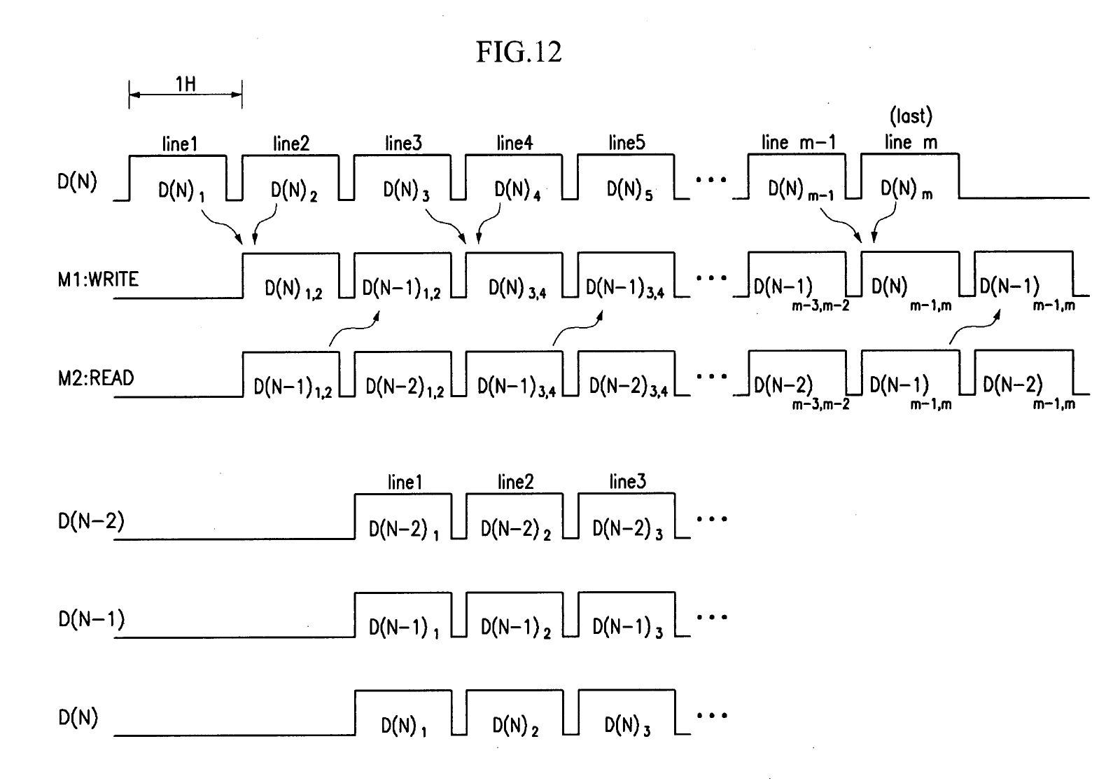

Referring to FIGS. 9-11, the operation of the signal processing device shown in FIG. 8 is described in detail.

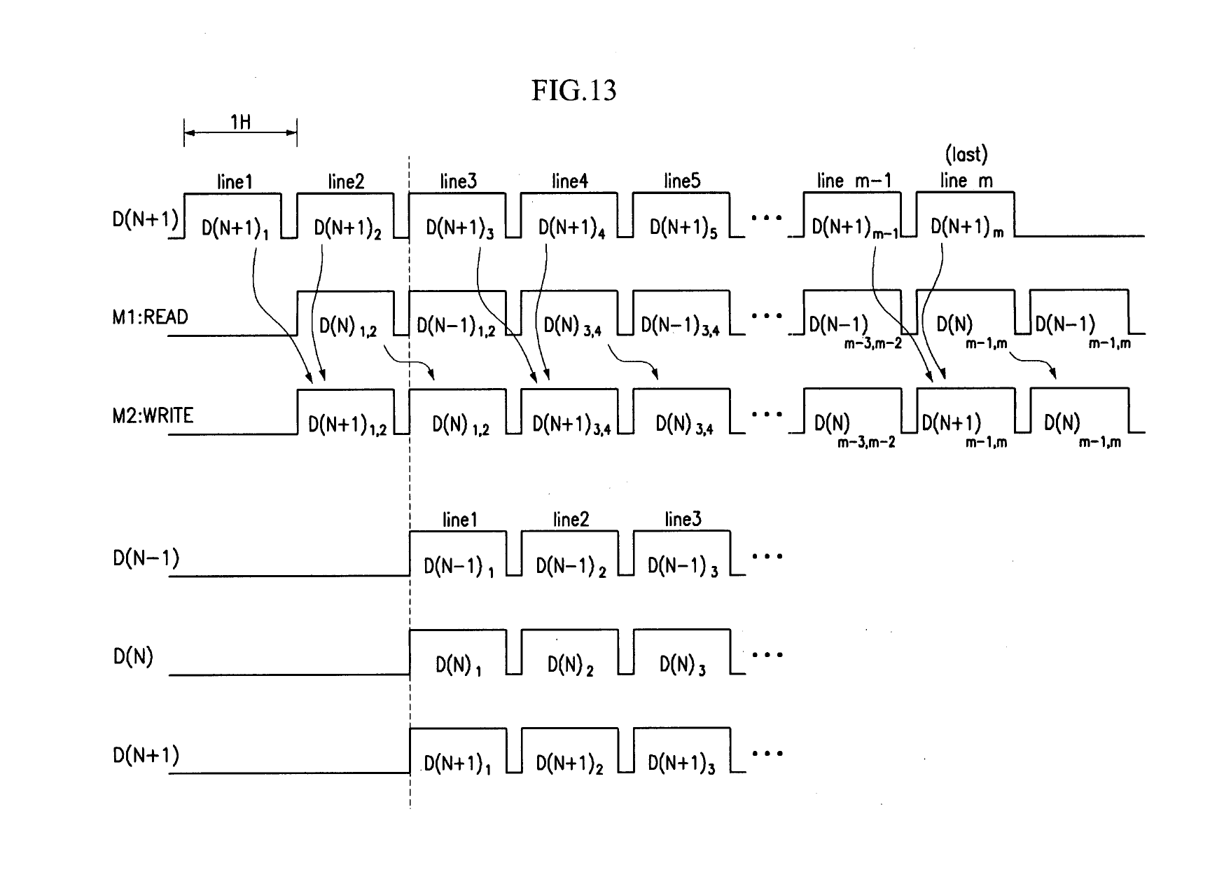

FIGS. 9 and 10 illustrate exemplary waveforms of input and output signals of the signal processor shown in FIG. 8, respectively, and FIG. 11 illustrates exemplary waveforms of the image data read from or written into the frame memories.

Referring to FIG. 9, 48-bit input image data are input at a first clock period of 1.5T′ corresponding to a first clock frequency, for example, 54 MHz. Each of the 48-bit input image data entering the signal processor 52 includes three 16-bit sub-data (data[47:32], data[31:16], and data[15:0]) and thus twelve 16-bit sub-data are input for a given time X equal to four first clock periods.

Referring to FIG. 10, the signal processor 52 converts the 48-bit input image data at the first clock frequency into the 32-bit output image data (data[31:16] and data[15:0]) at a second clock frequency, for example, 81 MHz. The conversion is performed in substantially the same manner as that in the previous embodiment, and thus the detailed description thereof is omitted. Here, T′ is a second clock period corresponding to the second clock frequency and equal to two thirds of the first clock period. Twelve 16-bit sub-data are converted for the given time X equal to six second clock periods.

Accordingly, the number of the output data is equal to that of the input data during the given period X.

Referring to FIG. 11, the frame memories 54 and 56 read or write at both rising and falling edges of a clock having the second clock frequency. Therefore, the time required for processing the twelve 16-bit input sub-data is equal to three clock periods that are equal to 0.5X. As a result, this embodiment stores the image data into the frame memories 54 and 56 for a half of the input time.

The first frame memory 54 and the second frame memory 56 are connected to the signal processor 52 via respective data buses. This means that the signal processor 52 can independently and simultaneously access the frame memories 54 and 56. On the contrary, the first and the second frame memories 54 and 56 preferably share a common address bus.

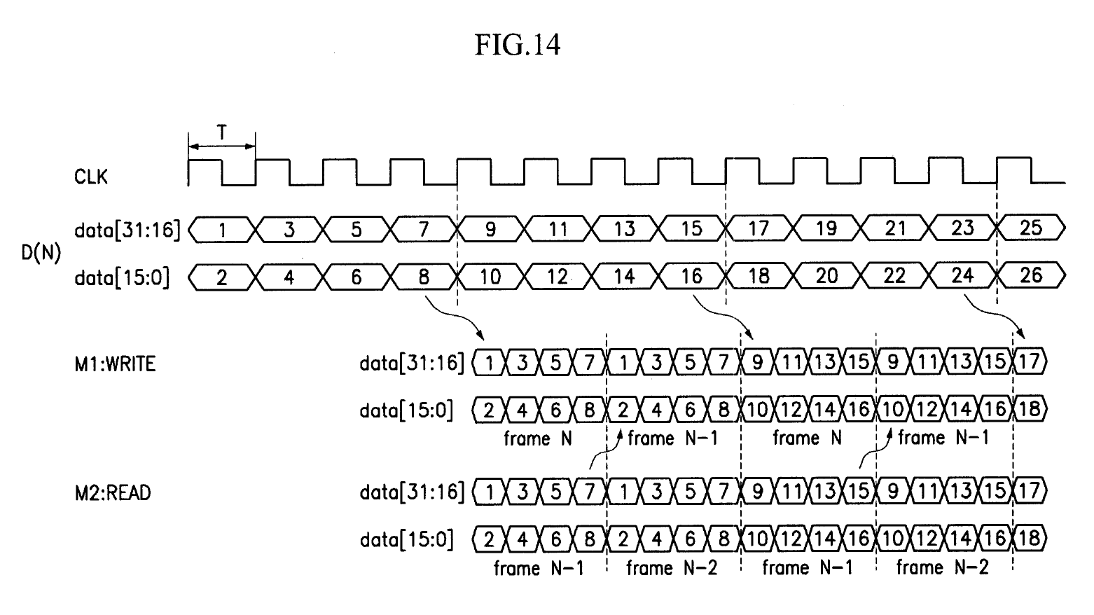

The signal processor 52 writes one of the first and the second frame memories 54 and 56 and, simultaneously, reads the other of the frame memories 54 and 56, which will be described in detail with reference to FIGS. 12-15.

FIGS. 12 and 13 illustrate an example of the operation of the signal processor shown in FIG. 8 during the input of N-th and (N+1)-th frames, respectively.

It is assumed that an LCD according to this embodiment includes a plurality of pixel rows, for example, m pixel rows. The image data of an N-th frame after the conversion of the bit number and the clock frequency as shown in FIG. 10 are denoted by D(N), the image data for an i-th pixel row (referred to as “i-th row data” hereinafter) among the image data of the N-th frame are denoted by D(N)ᵢ, and the image data in the i-th pixel row and the (i+1)-th pixel row among the image data of the N-th frame are denoted by D(N)_{i,i+1}.

Referring to FIG. 12, the signal processor 52 processes the converted image data row by row. The signal processor 52 include a plurality of line memories (not shown), each capable of storing the image data for a pixel row.

It is assumed that the first frame memory (M1) 54 writes the image data of the N-th frame, while the second frame memory (M2) 56 reads the image of the (N-1)-th frame.

During the input of a first row data D(N)₁, of the N-th frame, the signal processor 52 stores D(N)₁ into a first line memory (not shown).

During the input of a second row data D(N)₂ of the N-th frame, the signal processor 52 writes D(N)₁ from the first line memory into the first frame memory 54, and it stores D(N)₂ into a second line memory (not shown) and writes D(N)₂ into the first frame memory 54. At the same time, the signal processor 52 reads D(N−1)₁ and D(N−1)₂ from the second frame memory 56 and stores them into third and fourth line memories (not shown). The frame memories 54 and 56 can process the image data for two pixel rows during a period of 1H.

During the input of a third row data D(N)₃ of the N-th frame, the signal processor 52 compares the image data of the (N−2)-th, the (N−1)-th, and the N-th frames for data modification. In detail, the signal processor 52 reads D(N)₁ stored in the first line memory, D(N−1)₁ stored in the third line memory, and D(N−2)₁ stored in the second frame memory 56, and compares them to generate modified image data. At the same time, the signal processor 52 stores D(N)₃ into the first line memory that have stored D(N)₁. This requires no further additional line memory. Furthermore, the signal processor 52 writes D(N−1)₁ and D(N−1)₂ into the first frame memory 54 and it reads D(N−2)₁ and D(N−2)₂ from the second frame memory 56 and stores them into fifth and sixth line memories (not shown) for data comparison.

During the input of a fourth row data D(N)₄ of the N-th frame, the signal processor 52 reads D(N)₂ stored in the second line memory, D(N−1)₂ stored in the fourth line memory, and D(N−2)₂ stored in the sixth line memory and compares them to generate a modified image data. At the same time, the signal processor 52 the signal processor 52 stores D(N)₄ into the second line memory that have stored D(N)₂. This requires no further additional line memory. Furthermore, the signal processor 52 writes D(N−1)₃ into the first frame memory 54 and it stores D(N−2)₄ into the second line memory and writes it into the first frame memory 54. In addition, the signal processor reads D(N−1)₃ and D(N−1)₄ from the second frame memory 56 and stores them into the third and the fourth line memories for the data comparison.

The signal processor 52 repeats the operation for the image data from the fifth pixel row and the m-th pixel row.

In this way, the signal processor 52 writes D(N) into the first frame memory 54 such that the first frame memory 54 stores D(N) and D(N−1) and the second first frame memory 56 stores D(N−1) and D(N−2), and thereby, the two frame memories 54 and 56 store three frame data. Moreover, the signal processor 52 reads from and writes into the frame memories 54 and 56 and, simultaneously, compares the image data of the (N−2)-th, the (N−1)-th, and the N-th frames to generate modified image data.

Referring to FIG. 13, the first frame memory 54 and the second frame memory 56 exchanges their role during the input of the image data for the (N+1)-th frame such that the first frame memory 54 performs reading operation and the second frame memory 56 performs writing operation. That is, the signal processor 52 reads D(N) and D(N−1) stored in the first frame memory 54 and stores them into the line memories for the data comparison and it writes D(N+1) input from an external device and D(N) stored in the line memories into the second frame memory 56. Then, the. first frame memory 54 stores D(N) and D(N−1), and the second frame memory 56 stores D(N+1) and D(N).

The detailed description of such an operation of the signal processor 52 and the frame memories 54 and 56 is omitted since the operation for the (N+1)-th frame is substantially the same as that for the N-th frame.

This operation repeats for successive frames.

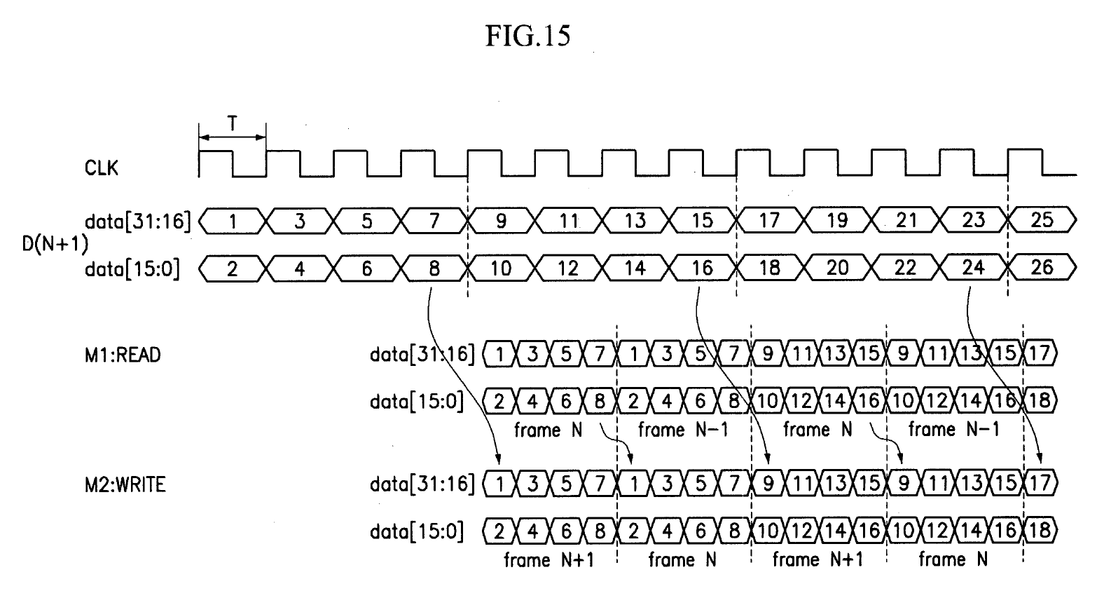

FIGS. 14 and 15 illustrate another example of the operation of the signal processor shown in FIG. 8 during the input of N-th and (N+1)-th frames, respectively.

The converted image data of an N-th frame as shown in FIG. 10, which are denoted by D(N), are divided by 16 bits into a plurality of data segments and the i-th data segments are denoted by D(N)(i), and the i-th data segments to the (i+1)-th data segments are denoted by D(N)(i,j).

Referring to FIG. 14, eight 16-bit image data are input into the signal processor 52 and the signal processor 52 processes the converted image data by unit of multiple clocks, for example, four clocks. The signal processor 52 may include a plurality of memories (not shown) such as flip-flops that can store eight 16-bit data.

It is assumed that the first frame memory (M1) 54 writes the image data of the N-th frame, while the second frame memory (M2) 56 reads the image of the (N−1)-th frame.

During the first four clocks, i.e., first to fourth clocks, the signal processor 52 stores D(N)(1,8) into a first memory.

During the second four clocks, i.e., fifth to eighth clocks, the signal processor 52 stores D(N)(9,16) into a second memory. In addition, D(N)(1,8) stored in the first memory is written into the first frame memory 54 and D(N−1)(1,8) is read from the second frame memory 56 and stored in a third memory during the fifth and the sixth clocks. During the seventh and the eighth clocks, D(N−1)(1,8) is read from the third memory and written into the first frame memory 54 and D(N−2)(1,8) is read from the second frame memory 56 and stored into a fourth memory.

In the meantime, the signal processor 52 reads out and compares the image data of the N-th, the (N−1)-th, and the (N−2)-th frames for data modification during the seventh and the eighth clocks. In detail, D(N)(1,8) stored in the first memory, D(N−1)(1,8) stored in the third memory, and D(N−2)(1,8) stored in the fourth memory are read out bit by bit and generates modified image data.

During the third four clocks, i.e., ninth to twelfth clocks, the signal processor 52 stores D(N)(17,24) into the first memory. In addition, D(N)(9,16) stored in the second memory are written the first frame memory 54, D(N−1)(9,16) are read out from the second frame memory 56 and written into the third memory during the ninth and the tenth clocks. During the eleventh and the twelfth clocks, D(N−1)(9,16) are read out from the third memory and written into the first frame memory 54 and D(N−2)(9,16) from the second frame memory 56 is stored in the fourth memory.

During the eleventh and the twelfth clocks, the signal processor 52 sequentially reads out and compares D(N)(9,16) stored in the second memory, D(N−1)(9,16) stored in the third memory, and D(N−2)(9,16) stored in the fourth memory and generates modified image data.

In this way, all the image data of the N-th frame are processed during successive clocks.

Accordingly, D(N) is written in the first frame memory 54 and thus D(N) and D(N−1) are stored in the first frame memory 54, while D(N−1) and D(N−2) are stored in the second first frame memory 56 such that the two frame memories 54 and 56 store the image data for three frames. In addition, the signal processing device reads and writes the frame memories 54 and 56 and reads and compares the image data the (N−2)-th, the (N−1)-th, and the N-th frames to generate modified image data.

Referring to FIG. 15, the first frame memory 54 and the second frame memory 56 exchange their roles during the input of the image data for the (N+1)-th frame such that the first frame memory 54 performs reading operation and the second frame memory 56 performs writing operation. That is, the signal processor 52 reads D(N) and D(N−1) stored in the first frame memory 54 and stores them into the memories for the data comparison and it writes D(N+1) input from an external device and D(N) stored in the memories into the second frame memory 56. Then, the first frame memory 54 stores D(N) and D(N−1), and the second frame memory 56 stores D(N+1) and D(N).

The detailed description of such an operation of the signal processor 52 and the frame memories 54 and 56 is omitted since it the operation for the (N+1)-th frame is substantially the same as that for the N-th frame.

This operation repeats for successive frames.

The image data processing by a unit of four clocks according to this embodiment requires no line memory. Instead of the memories, memories having a small storing capacity are utilized to reduce the size of the signal processing device and the manufacturing cost.

The timing and the number of the clocks included in a unit for image data processing of the signal processor 52 and the frame memories 54 and 56 may be varied.

As described above, the conversion of the bit number and the frequency of the input image data can make one frame memory store the image data of two frames, and the DDR RAM along with the above-described bit number and frequency conversion can make two frame memories store the image data of three frames for data modification. For example, the image data can be modified by comparing the image data of three frames.

In the meantime, the signal processing device may further include data input/output unit(s) for directly transmitting/receiving the image data to/from the DDR memory, which will be described in detail. The data input/output unit may be disposed between a signal processor and the DDR memory.

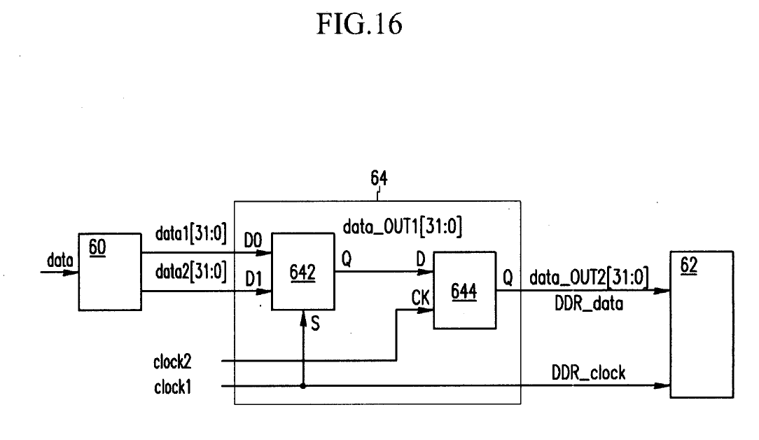

Now, signal processing devices including a DDR memory according to embodiments of the present invention will be described in detail with reference to FIGS. 16-19.

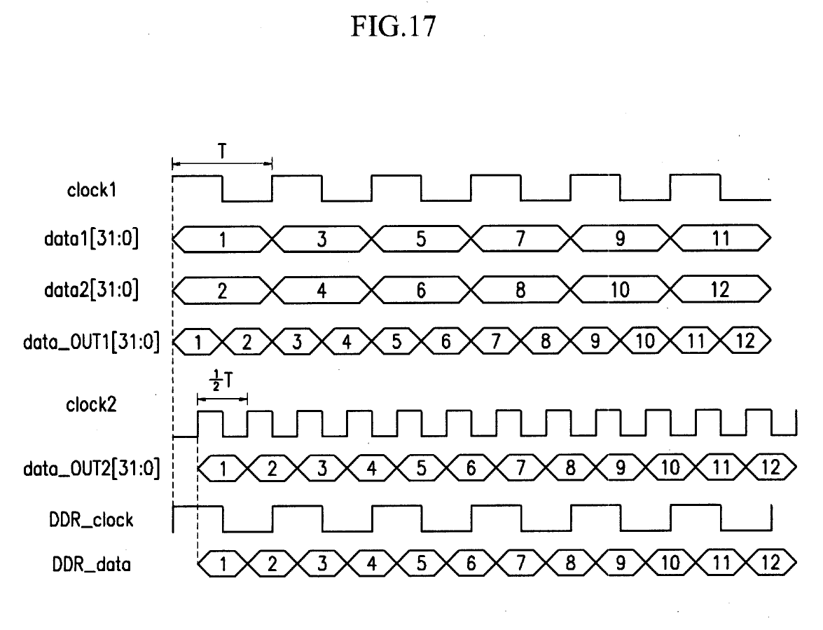

FIG. 16 is a block diagram of a signal processing device including a data output unit according to an embodiment, and FIG. 17 is a timing chart of signals of elements of the signal processing device shown in FIG. 16.

Referring to FIG. 16, a signal processing device according to this embodiment includes the signal processor 60, the data output unit 64, and a DDR memory 62. The data output unit 64 includes a multiplexer 642 and a flip-flop 644.

32-bit input image data (data1[31:0] and data2[31:0]) from the signal processor 60 are input into input terminals D0 and D1 of the multiplexer 642. The first clock (clock1) having a predetermined period T is input into a selection terminal S of the multiplexer 642, and the multiplexer 642 outputs one of the image data (data1[31:0] and data2[31:0]) input into the input terminals D0 and D1 through an output terminal Q in synchronization with the first clock (clock1). In detail, the multiplexer 642 outputs the image data (data1[31:0]) of the input terminal D0 when the first clock (clock 1) is in a high level, while it outputs the image data (data2[31:0]) of the input terminal D1 when the first clock (clock1) is in a low level. Referring to FIG. 17, the multiplexer 642 synthesizes the image data (data1[31:0], data2[31:0]) by alternately arranging them to generate output data (data_OUT1 [31:0]) having a period (T/2) equal to the period (T) of the input data (data1[31:0], data2[31:0]). The output data (data_OUT1[31:0]) is input into the flip-flop 644. The flip-flop 644 outputs the image data (data_OUT1[31:0]) that was received by its input terminal D through its output terminal Q in synchronization with rising edges of a second clock (clock2). The output image data (data_OUT2[31:0]) of the flip-flop 644 are input into the DDR memory 62 and stored therein in synchronization with the first clock (clock1). The frequency (2/T) of the second clock (clock2) used in the data output unit 64 is twice the frequency (1/T) of the first clock (clock1) used in the DDR memory 62 as shown in FIG. 17.

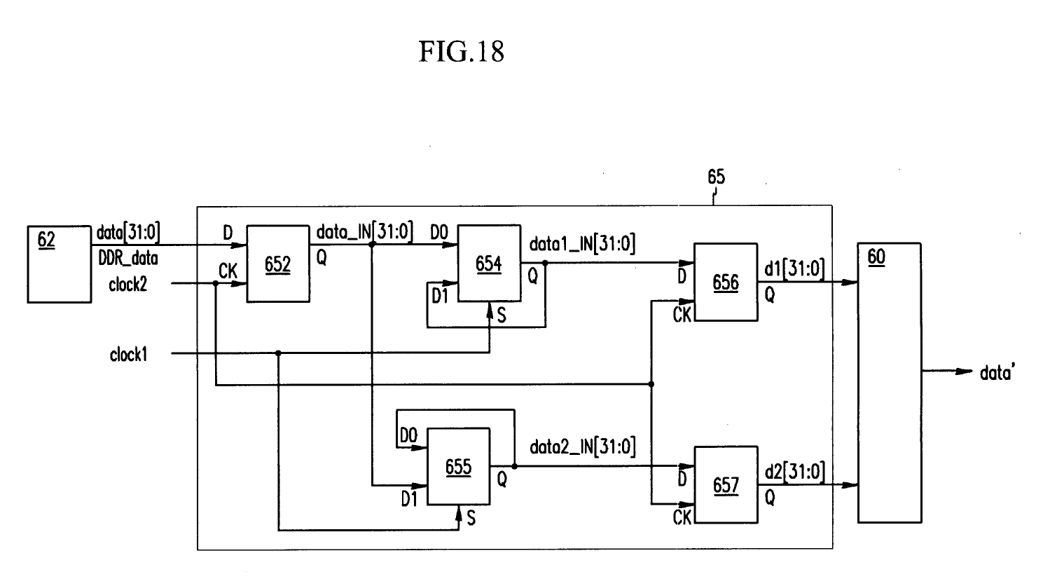

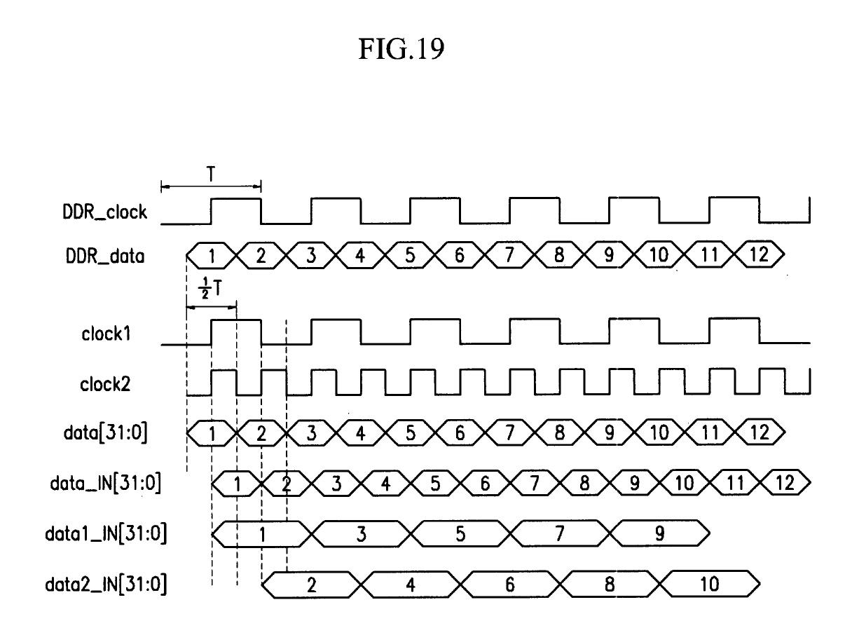

FIG. 18 is a block diagram of a signal processing device including a data input unit according to an embodiment, and FIG. 19 is a timing chart of signals of elements of the signal processing device shown in FIG. 18.

Referring to FIG. 18, a signal processor includes a signal processor 60, a data input unit 65, and a DDR memory 62. The data input unit 65 includes first and second multiplexers 654 and 655 and first to third flip-flops 652, 656 and 657.

Image data DDR_data from the DDR memory 62 are input into the first flip-flop 652 and the image data (data[31:0]) of an input terminal D of the first flip-flop 652 are outputted from an output terminal Q of the first flip-flop 652 in synchronization with rising edges of the above-described second clock (clock2). Output data (data_IN[31:0]) of the first flip-flop 652 are input into an input terminal D0 of the first multiplexer 654 and into an input terminal D1 of the second multiplexer 655. Since the input terminal D1 and an output terminal Q of the second multiplexer 654 are connected to each other and the input terminal D0 and an output terminal of the third multiplexer 655 are connected to each other, the first and the second multiplexers 654 and 655 convert the image data (data_IN[31:0]) having a period of 0.5T into the image data having a period of T and output them. The above-described first clock (clock1) equal to an operation clock (DDR_clock) of the DDR memory 62 is input into the selection terminals S of the first and the second multiplexers 654 and 655, the first multiplexer 654 outputs odd image data (data1_IN[31:0]) among the image data (data_IN[31:0]) and the second multiplexer 655 outputs even image data(data2_IN[31:0]) in synchronization with the first clock (clock1). The image data (data1_IN[31:0], data2_IN[31:0]) are input into the signal processor 60 through the second and the third flip-flops 656 and 657. Like the above-described data output unit 64, the frequency 2/T of the second clock (clock2) used in the data input unit 65 is twice the frequency 1/T of the first clock (clock1) used in the DDR memory 62 as shown in FIG. 19.

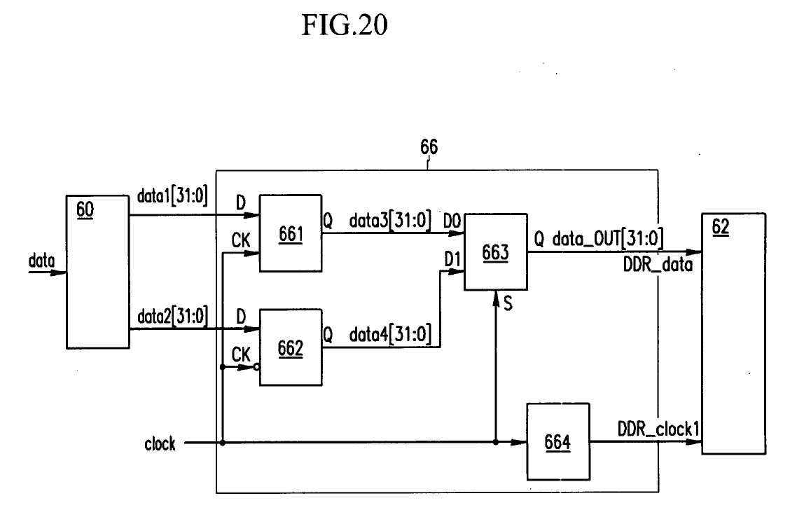

Now, signal processors according to other embodiments of the present invention will be described in detail with reference to FIGS. 20-23.

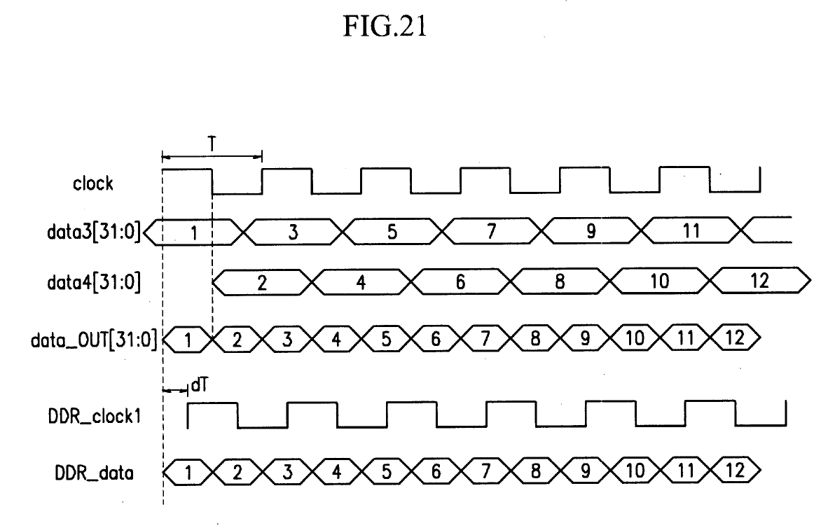

FIG. 20 is a block diagram of a signal processing device including a data output unit according to another embodiment, and FIG. 21 is a timing chart of signals of elements of the signal processing device shown in FIG. 20.

Referring to FIG. 20, a data processing device according to this embodiment includes a signal processor 60, a data output unit 66 connected to the signal processor 60 for synthesizing input image data, and a DDR memory 62 connected to the data output unit 66.

The data output unit 66 includes the first and the second flip-flops 661 and 662 connected to the signal processor 60, a multiplexer 663 having an input terminal connected to the first and the second flip-flops 661 and 662 and an output terminal connected to the DDR memory 62, and a clock delay unit 664 generating a delay clock (DDR_clock1) and inputting the delay clock (DDR_clock1) into the DDR memory 62. The delay clock (DDR_clock1) is obtained by delaying an input clock (clock) having a predetermined period (T) by a predetermined amount of dT, which is input into the first and the second flip-flops 661 and 662 and the multiplexer 663.

Now, an operation of the signal processor shown in FIG. 20 is described in detail with reference to FIG. 21.

The signal processor 60 receives image data from an external device and divides the image data into two sub-data to be outputted in synchronization with the input clock (clock) having a predetermined period. In this embodiment, the signal processor 60 outputs 32-bit odd image data (data1[31:0]) to an input terminal D of the first flip-flop 661 and outputs even image data(data2[31:0]) to an input terminal D of the second flip-flop 662.

The first flip-flop 661 latches the input image data (data1[31:0]) into an output terminal Q in synchronization with rising edges of the input clock (clock), the second flip-flop 662 the input image data (data2[31:0]) into an output terminal Q in synchronization with falling edges of the input clock (clock). Then, the output image data (data3[31:0]) of the first flip-flop 661 and the output image data (data4[31:0]) of the second flip-flop 662 alternates by a half period (0.5T) of the input clock (clock) as shown in FIG. 21.

The image data (data3[31:0] and data4[31:0]) are input into the input terminals D0 and D1 of the multiplexer 663. The input clock (clock) is input into a selection terminal S of the multiplexer 663 and the multiplexer 663 outputs one of the image data entering the input terminals D0 and D1 through the output terminal Q in synchronization with the input clock (clock). In detail, the multiplexer 663 outputs the image data (data3[31:0]) of the input terminal D0 when the input clock (clock) is in a high level, while it outputs the image data (data4[31:0]) of the input terminal D1 when the input clock (clock) is in a low level. Referring to FIG. 21, the multiplexer 663 synthesizes the output image data (data3[31:0], data4[31:0]) from the first and the second flip-flops 661 and 662 to generate output data having a period (0.5T) equal to half of the period (T) of the input data (data1[31:0], data2[31 :0]). The synthesis of the image data alternately outputs the output image data (data3[31:0], data4[31:0]) from the first and the second flip-flops 661 and 662.

The output data (data_OUT[31:0]) are input into the DDR memory 62. The DDR memory 62 writes the image data (data_OUT[31:0]) into suitable addresses at the rising and falling edges of the delay clock (DDR_clock1) from the clock delay unit 664. The delay time dT of the delay clock (DDR_clock1) is determined for the image data (data_OUT[31:0]) to have a margin for a setup time and a hold time so that the DDR memory 62 normally processes the image data (data_OUT[31:0]).

Referring to FIG. 21, the frequency (1/T) of the input clock (clock) used in the data output unit 66 is equal to the frequency (1/T) of the delay clock (DDR_clock1) used in the DDR memory 62.

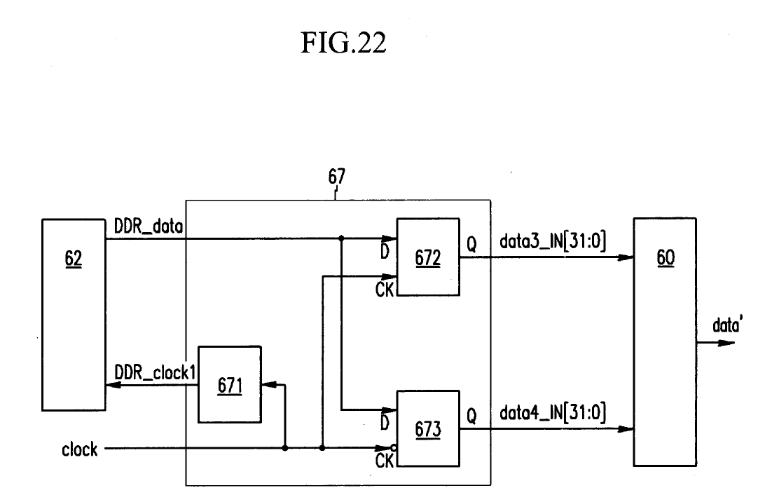

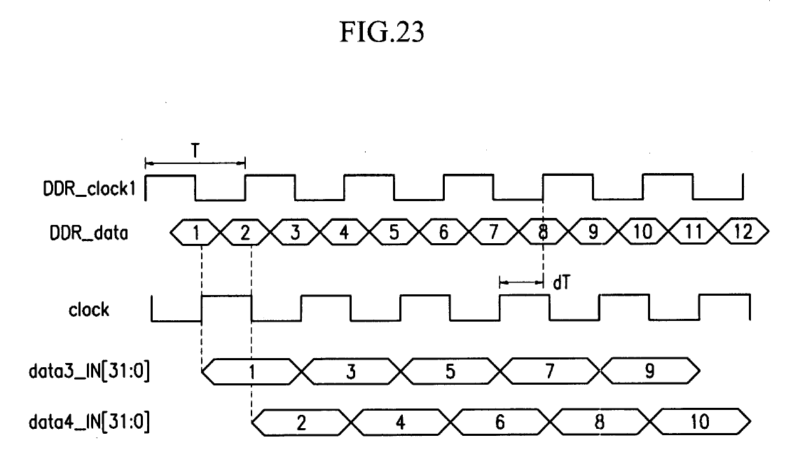

FIG. 22 is a block diagram of a signal processing device including a data input unit according to another embodiment, and FIG. 23 is a timing chart of signals of elements of the signal processing device shown in FIG. 22.

Referring to FIG. 22, a signal processor according to another embodiment of the present invention includes a DDR memory 62 storing image data, a data input unit 67 connected to the DDR memory 62 and dividing the image data from the DDR memory 62, and a signal processor 60 connected to the data input unit 67.

The data input unit 67 includes first and second flip-flops 672 and 673 having input terminals connected to the DDR memory 62 and output terminals connected to the signal processor 60, and a clock delay unit 671 generating a delay clock (DDR_clock1) and inputting the delay clock (DDR_clock1) into the DDR memory 62. The delay clock (DDR_clock1) is obtained by delaying an input clock (clock) having a predetermined period (T) by a predetermined amount of time dT, which is input into the first and the second flip-flops 672 and 673.

Now, an operation of the signal processor shown in FIG. 22 is described in detail with reference to FIG. 23.

The DDR memory 62 outputs the image data DDR_data stored in the DDR memory 62 having a period of 0.5T in synchronization with rising and falling edges of the delay clock (DDR_clock1). The output image data DDR_data are input into the first and the second flip-flops 672 and 673.

The first flip-flop 672 outputs odd data (data3_IN[31:0]) among the image data DDR_data in synchronization with the rising edges of the input clock (clock), the second flip-flop 673 outputs even data (data4_IN[31:0]) with the falling edges of the input clock (clock). The odd data (data3_IN[31:0]) and the even data (data4_IN[31:0]) vary by a period of T and are input into the signal processor 60.

The signal processor 60 receives and modifies the image data from the first and the second flip-flops 672 and 673 and outputs the modified image data.

In the meantime, the delay time dT of the delay clock (DDR clock1) is determined so that the DDR memory 62 and the first and the second flip-flops 672 and 673 timely processes the image data and provide the processed image data for the signal processor 60.

Referring to FIG. 23, the frequency (1/T) of the input clock (clock) used in the data input unit 67 is equal to the frequency (1/T) of the delay clock (DDR_clock1) used in the DDR memory 62, like the previous embodiment.

A signal processing device according to another embodiment of the present invention may include both the data output unit 66 and the data input unit 67. The signal processor 60 may include the data output unit 66 or the data input unit 67.

As described above, the data output unit 66 and the data input unit 67 according to this embodiment uses a clock signal having a frequency (1/T) that is equal to that used in the signal processor, while the data output unit 64 and the data input unit 65 in the previous embodiment uses a clock signal having a frequency (2/T). Accordingly, the signal processing device according to this embodiment reduces power consumption and electromagnetic interference and alleviates the complexity for producing a high-frequency clock signal to reduce the manufacturing cost.

Although preferred embodiments of the present invention have been described in detail hereinabove, it should be clearly understood that many variations and/or modifications of the basic inventive concepts herein taught which may appear to those skilled in the present art will still fall within the spirit and scope of the present invention, as defined in the appended claims.

1. A signal processing device for a display unit, the device comprising:
a signal processor that receives current image data in a first format and generates a modified current image data in a second format, the first format having a first bit number and a first frequency and the second format having a second bit number and a second frequency; and
a frame memory that stores the image data in the second format.

2. The device of claim 1, wherein the signal processor comprises:
a data converter that changes a bit number of the current image data from the first bit number to the second bit number to generate image data in an intermediate format that has the second bit number and the first frequency; and
an internal memory connected to the data converter, wherein the internal memory receives the current image data in the intermediate format and changes a frequency of the current image data from the first frequency to the second frequency.

3. The device of claim 2 further comprising:
a data output block connected to the internal memory, the data output block receiving the current image data in the second format and forwarding the current image data to the frame memory; and
a data modifier connected to the data output block and the frame memory, the data modifier receiving the current image data, image data for a first frame, and image data for a second frame, the data modifier comparing the image data for the first frame, image data for the second frame, and the current image data to generate the modified current image data.

4. The device of claim 3, wherein the data modifier retrieves the image data for the first frame and the image for the second frame from the frame memory.

5. The device of claim 3, wherein the data modifier retrieves the image data for the first frame from the data output block and the image data for the second frame from the frame memory.

6. The device of claim 2, wherein the first bit number is a multiple of 24 bits and the second bit number is 32 bits.

7. The device of claim 2, wherein the internal memory comprises either a First-In-First-Out (FIFO) memory or Dual-Port RAM.

8. The device of claim 1, wherein a product of the first bit number and the first frequency is equal to a product of the second bit number and the second frequency.

9. The device of claim 1, wherein the frame memory is a first frame memory, further comprising a second frame memory connected to the signal processor independently of the first frame memory, wherein the first frame memory performs write operation and the second frame memory performs read operations, and wherein both frame memories store image data in the second format.

10. The device of claim 9, wherein the signal processor operates at either a rising edge or a falling edge of a clock, and wherein the first frame memory and the second frame memory read or write at the rising edge and the falling edge of a clock, so that the image data stored in the first and the second frame memories are half as long as the image data in the signal processor.

11. The device of claim 9, wherein the first frame memory and the second frame memory share a common address bus but have separate data buses connecting the respective frame memory to the signal processor.

12. The device of claim 1, wherein the signal processor has a plurality of line memories, each of the line memories capable of storing image data for a pixel row in the display unit.

13. A method of processing data in a display device, the method comprising:
receiving current image data having a first bit number and a first frequency;
reformatting the current image data by rearranging the bits to a second bit number;
changing the first frequency to a second frequency;
storing the current image data having the second bit number and the second frequency in a frame memory; and
generating a modified current image data by using the current image data.

14. The method of claim 13 further comprising retrieving image data for a first frame and image data for a second frame, and comparing the image data for the first frame, the image data for the second frame, and the current image data to generate the modified current image data.

15. A method of processing data in a display device upon receipt of a current image data D(N) that includes a current first row data D(N)₁, a current second row data D(N)₂, and a current third row data D(N)₃, the method comprising:
storing D(N)₁ into a first line memory of a plurality of line memories in response to receiving D(N)₁, each line memory being capable of storing image data for a pixel row;
storing current second row data D(N)₂ into a second line memory of the plurality of line memories, and writing D(N)₁ and D(N)₂ from the first line memory and the second line memory, respectively, into a first frame memory in response to receiving D(N)₂;
reading a previous first row data D(N−1)₁ and second row data D(N−1)₂ from a second frame memory and storing them in third and fourth line memories, wherein the writing of D(N)₁ and D(N)₂ into the first frame memory and the reading of D(N−1)₁ and D(N−1)₂ from the second frame memory occur substantially simultaneously.

16. The method of claim 15 further comprising:
storing an old row data D(N−2) in a second frame memory; and
comparing a previous image data D(N−1), the old image data D(N−2), and the current image data D(N) for data modification.

17. The method of claim 16 further comprising:
reading D(N)₁ from the first line memory;
reading D(N−1)₁ from the third line memory; and
reading an old first row data D(N−2)₁ stored in the second frame memory to compare D(N)₁, D(N−1)₁, and D(N−2)₁ and generate a modified value.

18. The method of claim 17 further comprising replacing the current first row data D(N)₁ with a current third row data D(N)₃ in the first line memory after reading D(N)₁ from the first line memory.

19. The method of claim 17 further comprising:
writing D(N−1)₁ and D(N−1)₂ into the first frame memory; and
reading D(N−2)₁ from the second frame memory and storing it in a fifth line memory; and
reading D(N−2)₂ from the second frame memory and storing it in a sixth line memory.

20. The method of claim 15 further comprising storing first eight bits of current image data D(N) into a first memory during first four clock cycles.

21. A method of processing data in a display device having a signal processor with a first memory, a second memory, a third memory, and a fourth memory and a first frame memory and a second frame memory that are separate from the signal processor, the method comprising:
storing a first portion of first image data D(N) into the first memory;
simultaneously storing a second portion of the first image data D(N) into the second memory, writing the first portion of the first image data D(N) from the first memory to the first frame memory, and reading a first portion of a second image data D(N−1) from the second frame memory into the third memory; and
simultaneously reading the first portion of the second image data D(N−1) from the third memory, writing the first portion of the second image data D(N−1) into the first frame memory, reading a first portion of a third image data D(N−2) into the second frame memory, storing the first portion of the third image data D(N−2) into the fourth memory, and comparing the first, second, and third image data to generate a modified image data.

22. A method of processing data in a display device upon receipt of next image data D(N+1), the method comprising:
reading current image data D(N) from a first frame memory and writing D(N) into a first line memory;
reading previous image data D(N−1) from the first frame memory and writing D(N−1) into a second line memory;
writing D(N+1) into the second frame memory, such that the first frame memory stores D(N) and D(N−1) and the second frame memory stores D(N) and D(N+1).

23. A display device comprising:
a display panel having data lines and gate lines;
a data driver for sending signals to the data lines to display a preselected image;
a gate driver for sending signals to the gate lines to display the preselected image; and
a signal controller for controlling the data driver and the gate driver, wherein the signal controller includes a signal processor that receives current image data in a first format and generates a modified current image data in a second format, the first format having a first bit number and a first frequency and the second format having a second bit number and a second frequency.

24. A signal processing device for a display unit, the device comprising:
a signal processor that receives image data having a first data rate and divides the image data into a first subset of image data and a second subset of image data;
data output unit receiving the first subset and the second subset of image data and generating a recombined image data having a second data rate; and
a frame memory that stores the recombined image data according to a first clock rate.

25. The device of claim 24, wherein the second data rate is twice as fast as the first data rate, so that twice as many of the recombined image data as the first subset and second subset of image data is transmitted in a given time period.

26. The device of claim 24, wherein the data output unit comprises:
a multiplexer receiving the first and second subsets of image data; and
a flip-flop receiving a multiplexer output and generating the recombined image at a second clock rate.

27. The device of claim 26, wherein the multiplexer operates according to the first clock rate and the flip-flop operates according to the second clock rate that is double the first clock rate.

28. The device of claim 27, wherein the frame memory is a double data rate memory.

29. The device of claim 24, wherein the data output unit comprises:
a first flip-flop that receives the first subset of image data and generates a first flip-flop output;
a second flip-flop that receives the second subset of image data and generates a second flip-flop output; and
a multiplexer that receives the first flip-flop output and the second flip-flop output and generates the recombined image data.

30. The device of claim 29 further comprising a clock delay unit that creates a delay of dT in a clock cycle that is applied to the frame memory.

31. The device of claim 29, wherein the first subset of image data and the second subset of image data are offset from each other by half a clock cycle.

32. The device of claim 29, wherein the multiplexer outputs the first subset of image data when a clock is at a high level and outputs a second subset of current image data when the clock is at a low level.

33. A signal processing device for a display unit, the device comprising:
a double data rate (DDR) memory;
a data input unit receiving image data from the double data rate memory and generating a first subset of image data and a second subset of image data, wherein a data rate of the first subset and the second subset of image data is half of a data rate of the image data received from the memory; and
a signal processor receiving the first and second subsets of image data.

34. The device of claim 33, wherein the data input unit comprises:
a first flip-flop receiving the image data from the DDR memory and generating a first flip-flop output;
a first multiplexer and a second multiplexer receiving the first flip-flop output and generating a first multiplexer output and a second multiplexer output, respectively;
a second flip-flop and a third flip-flop receiving the first multiplexer output and the second multiplexer output, respectively.

35. The device of claim 33, wherein the double data rate memory and the first and the second multiplexers operate according to a first clock and the first, second, and third flip-flops operate according to a second clock having a clock rate about twice as fast as that of the first clock.

36. The device of claim 33, wherein the data input unit comprises:
a first flip-flop that receives the first subset of image data from the DDR memory; and
a second flip-flop that receives the second subset of image data from the DDR memory;
wherein the DDR memory outputs the first and second subsets of image data at a delayed version of a main clock cycle.

37. The device of claim 36 further comprising a clock delay unit that creates the delayed version of the main clock cycle and feeds the delayed version of the main clock cycle to the DDR memory.

38. A display device comprising:
a display panel having data lines and gate lines;
a data driver for sending signals to the data lines to display a preselected image;
a gate driver for sending signals to the gate lines to display the preselected image; and
a signal controller for controlling the data driver and the gate driver, wherein the signal controller includes:
a signal processor that receives image data having a first data rate and divides the image data into a first subset of image data and a second subset of image data; and
a data output unit receiving the first subset and the second subset of image data and generating a recombined image data having a second data rate, wherein the recombined image data is to be stored in a frame memory according to a first clock rate.

39. A display device comprising:
a display panel having data lines and gate lines;
a data driver for sending signals to the data lines to display a preselected image;
a gate driver for sending signals to the gate lines to display the preselected image;
a double data rate (DDR) memory; and
a signal controller for controlling the data driver and the gate driver, wherein the signal controller includes:
a data input unit receiving image data from the double data rate memory and generating a first subset of image data and a second subset of image data, wherein a data rate of the first subset and the second subset of image data is half of a data rate of the image data received from the memory; and
a signal processor receiving the first and second subsets of image data.
